(19) United States
(12) Patent Application Publication
(10) Pub. No.: US 2005/0172530 A1
(43) Pub. Date: Aug. 11, 2005

(54) Fold-out brochure for a plant tag

(76) Inventor: Kristi K. Huffman, Grand Rapids, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/051,866

(22) Filed: Feb. 4, 2005

Related U.S. Application Data
(60) Provisional application No. 60/542,697, filed on Feb. 6, 2004.

(51) Int. Cl. G09F 23/00

(52) U.S. Cl. 40/645; 40/124.13

(57) ABSTRACT

A plant tag includes a fold-out brochure attached to one surface of the tag by a transparent polymeric film to protectively cover the folded paper brochure underlying the clear polymeric film. The film has a peelable releasable adhesive edge to allow access to the brochure. The brochure, in one embodiment, is a color printed, multiple panel accordion folded paper brochure having information imprinted on opposite sides which relates to the plant with which the tag is associated on one side and on an opposite side, planting information regarding the use of the plant with complementary plants in a garden. The brochure and protective film can also be attached to a plant pot.

### CROSS-REFERENCE TO RELATED APPLICATIONS

This application claims priority under 35 U.S.C. § 119(e) on U.S. Provisional Application No. 60/542,697 entitled FOLD-OUT BROCHURE FOR A PLANT TAG, filed on Feb. 6, 2004, by Kristi K. Huffman, the entire disclosure of which is incorporated herein by reference.

### BACKGROUND OF THE INVENTION

The present invention relates to a protected fold-out brochure particularly suited for application to plant tags or pots to carry information for the care of an associated plant.

Plant tags of the type described in U.S. Pat. No. 6,401,375 are employed for the retail sales of live plants and include structure which allows the tag to be inserted into the potted plant and sold therewith. The tags have a limited surface area on which information can be printed. Typically, the front surface of the tag depicts the flowering plant in an adult stage and some limited information as to the amount of sunlight and water necessary for its care.

The tag's back panel also includes some information as to the size of the plant, sun exposure needs, and watering necessary for the plant's care. Although these tags have been extremely helpful in providing information as to the particular plant, the information available is somewhat limited due to the lack of a printable surface area on such tags.

There exists a need, therefore, for consumers to obtain more information regarding the plant with which a plant tag is associated. Also, it would be helpful to provide information regarding complementary plants which can be grouped with the particular plant in, for example, a garden setting.

### SUMMARY OF THE INVENTION

The fold-out brochure of the present invention includes a protective film having a peel-away front panel using a releasable adhesive for the compact packaging of the brochure on a plant tag or pot in a substantially planer state. The brochure allows the consumer, after purchase of the plant, to open the brochure for additional plant and garden information. In the preferred embodiment of the invention, the brochure is applied to a plant tag made of a weather resistant polymeric material and the brochure is attached to one surface of the plant tag, employing a transparent polymeric film having a releasable adhesive to protectively cover the folded paper brochure underlying the clear polymeric film. In the preferred embodiment of the invention, the brochure is a color printed, multiple panel folded paper brochure having information imprinted on opposite sides which relate to the plant with which the tag is associated on one side and on an opposite side, planting information regarding the use of the plant with complementary plants in a garden. In other embodiments, the fold-out brochure can carry other information to guide the consumer to other topics of relevance and interest. The brochure may also be applied to a pot for the plant.

These and other features, objects and advantages of the present invention will become apparent upon reading the following description thereof together with reference to the accompanying drawings.

### BRIEF DESCRIPTION OF THE DRAWINGS

FIG. 1 is a perspective view of a plant tag with a fold-out brochure embodying the present invention;

FIG. 2 is a perspective view of the plant tag shown in FIG. 1, showing one side of the fold-out brochure extended for viewing;

FIG. 3 is a perspective view of a plant tag shown in FIGS. 1 and 2, illustrating the opposite side of the fold-out brochure;

FIG. 4 is a greatly enlarged cross-sectional view of the plant tag, taken along section lines IV-IV of FIG. 1; and

FIG. 5 is an alternative embodiment of the invention showing the application of the brochure to a flowerpot.

### DETAILED DESCRIPTION OF THE PREFERRED EMBODIMENT

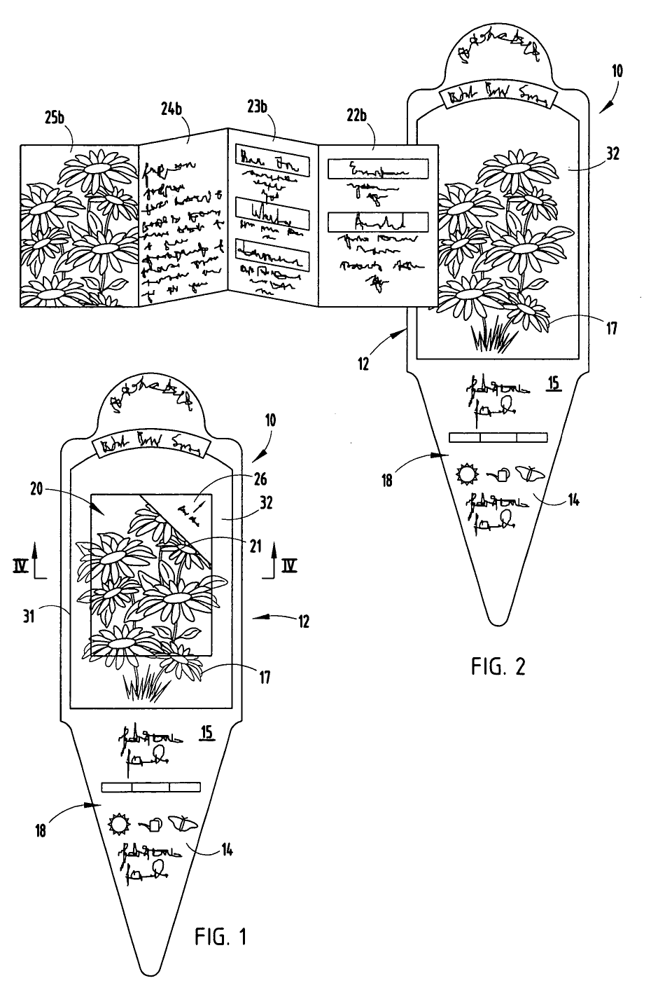

Referring initially to FIG. 1, there is shown a plant tag 10 embodying to present invention, which includes a generally rectangular body 12 and integral stake 14. The tag 10 is die cut of a suitable polymeric material, such as polyvinyl chloride having a thickness of from about 15 to about 22 mils. Tag 10 can be substantially identical to the tag construction disclosed in U.S. Pat. No. 6,401,375 the disclosure of which is incorporated herein by reference. Tag 10 includes a front surface 15 and a rear surface 16 (FIG. 4), which surfaces contain printed information thereon. Typically, front surface 15 will include a photograph 17 depicting the plant with which the tag is associated as well as a graphic display of exposure and care information 18 in the area near the junction of the stake 14 and tag body 12.

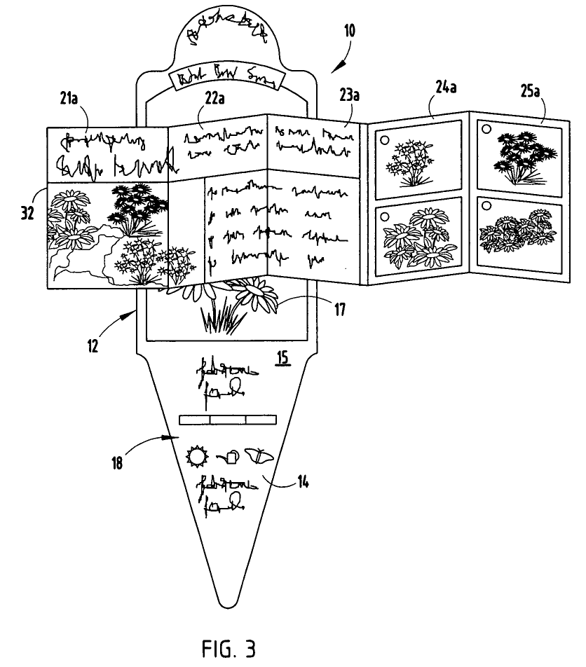

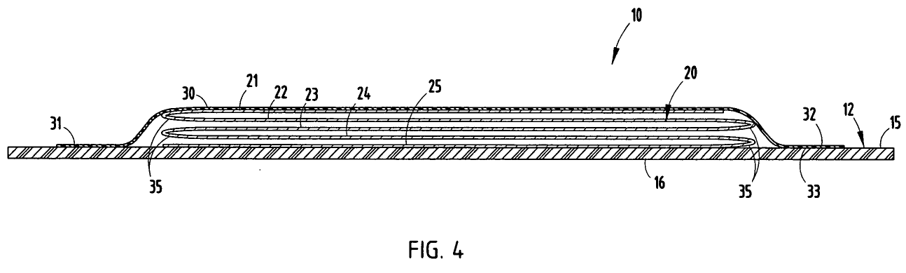

Tag 10 of the present invention further includes a fold-out brochure 20 attached to the front surface 15 of the tag, as best seen in FIG. 4, by a transparent, polymeric film 30 which extends over the edges of the five-panel accordion-folded paper brochure 20 of the embodiment shown. The transparent film 30 may be of any suitable polymeric material such as a 2 mil polyester. Brochure 20 has a first panel 21 which, as seen in FIG. 1, has a surface 21a having a photograph which aligns with and integrates with the depiction of photograph 17 on the face or front surface 15 of tag 10. The film includes a first edge 31 which extends beyond the left edge of the brochure 20 (as viewed in FIG. 1) and is adhered to the face 15 of tag body 12, as best seen in FIGS. 1 and 4. Film 30 also extends over the right edge of the brochure 20 and includes a right edge 32 which overlies and releasably attaches to the face 15 of tag body 12. The surface 33 (FIG. 4) of transparent film 30 facing the outer surface of panel 21 of brochure 20 and the face 15 of the tag body is coated with a contact adhesive to secure the film edge 31 to the tag and the film to the outer surface of brochure panel 21. The right edge 32 only of the film surface 33, however, is treated with an adhesive deadener such that edge 32 of film 30 is releasably attached to surface 15 of tag 10. This allows the brochure to be opened by peeling the transparent film 30 to expose fold-out brochure 20, as shown in FIGS. 2 and 3. The adhesive and the adhesive deadener are commercially available from a number of sources including Northwest Coating Corp of Oak Creek, Wis. The upper right corner 26 of the brochure panel 21 includes instructions indicating to the consumer the corner which can used initially to open the brochure into the use positions shown in FIGS. 2 and 3.

Brochure 20 includes five panels 21, 22, 23, 24, and 25, each with a front surface 21a through 25a and a rear surface 21b through 21b with printed matter on each of such surfaces. When the brochure is opened, as seen in FIG. 2, the rear surfaces 25b, 24b, 23b, and 22b are exposed and include photographs and information pertaining to the particular plant with which the tag is associated. When the brochure is unfolded to the position shown in FIG. 3, the front surfaces of panels 21 through 25 are exposed, namely, 21a, 22a, 23a, 24a, and 25a. Such information, as seen in FIG. 3, pertains to gardening information including the plant with which the tag is associated and other compatible plants and flowers which can be combined with the particular plant in a garden. Thus, accordion-folded brochure 20 provides the consumer with a significant amount of information which pertains not only to the plant with which the tag is associated at the point of sale but also general gardening information with respect to the use of the plant with other plants. Such information is helpful to the consumer as well as promoting for the retailer, the sale of additional plants. Brochure 20 can either be removed completed from the tag by the consumer, if desired, by removing the adhesive attaching edge 31 of transparent film 30 from the face 15 of the plant tag or the brochure can be refolded and resealed to the position shown in FIG. 1 and left with the plant tag. The film 30 provides a protective cover for the folded paper brochure and is resistant to watering of the plants and the high humidity of the greenhouse area of a garden center where the plants having such tags are generally located for sale.

While the brochure illustrated in FIGS. 1-4 is made of paper, it could be made of a polymeric film material as well, and the panels are folded along a plurality of fold lines 35, as seen in FIG. 4, to provide a compact brochure which is substantially planar. It is noted that the depiction in FIG. 4 is exaggerated so that the brochure panels can be clearly seen. In practice, the brochure does not extend significantly from the face 15 of the plant tag. In addition to having the brochure made of different materials, the information printed on the brochures may vary widely and include information which may be of interest to a consumer purchasing a plant or advertising information, tear-away sales or rebate coupons for the retailers, or the like to assist the consumer and/or retailer in the enjoyment of the products on which the brochure is attached or related merchandise.

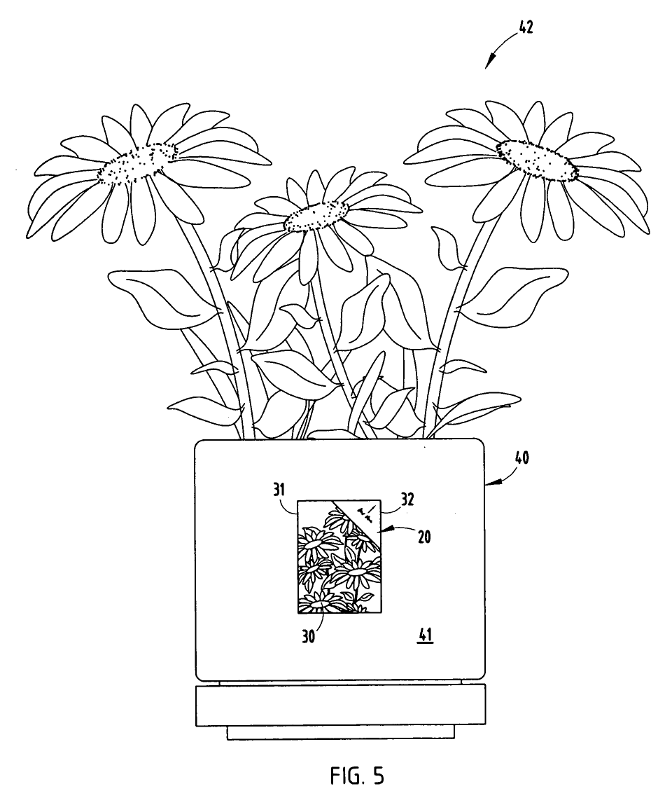

Although particularly beneficial for application to a relatively small plant tag, the brochure 20 and protective and holding film 30 can be applied to a flowerpot 40 as seen in FIG. 5. In FIG. 5 there is shown the same brochure 20 and covering film 30 as shown in FIGS. 1-4 but which is applied to the outer surface 41 of the flowerpot 40 at a location readily visible to the consumer at the point of sale. The edges 31 and 32 of film 30 adhere to pot surface 41 with edge 32 being releasable, as in the first embodiment, to allow the brochure 20 to be opened as seen in FIGS. 2 and 3. Pot 40 contains a live plant, such as flowering plant 42, which conforms to the information contained in the brochure 20. In this embodiment, a plant tag may be unnecessary since the brochure carries all the necessary information.

If desired, the plant tag 10 itself may be blank (i.e., free of printing) and the brochure 20 of the present invention serves to provide all of the desired information. It will become apparent to those skilled in the art that this and various other modifications to the preferred embodiment of the invention as described herein can be made without departing from the spirit or scope of the invention as defined by the appended claims.

1. A plant tag comprising:
a tag for use with plants, said tag having at least one surface exposed for receiving plant identification information thereon;
a fold-out brochure carrying printed indicia on at least one side thereof, said fold-out brochure having a plurality of folded panels; and
a polymeric film overlying said brochure and having a surface with a contact adhesive thereon for attaching said brochure to said surface of said tag.

2. The tag as defined in claim 1 wherein said brochure includes at least three panels which are accordion folded.

3. The tag as defined in claim 2 wherein at least one of said panels of said brochure has printed indicia on opposite sides.

4. The tag as defined in claim 3 wherein said brochure includes five accordion folded panels and wherein each panel includes printed indicia on opposite sides.

5. The tag as defined in claim 1 wherein said tag is made of a polymeric material.

6. The tag as defined in claim 5 wherein said film is a clear polyester film.

7. The tag as defined in claim 1 wherein said film has one edge engaging said tag that includes an adhesive deadener such that said film can be peeled away to open said brochure while remaining attached to said tag.

8. An informational brochure for association with live plants comprising:
a fold-out paper brochure carrying printed indicia thereon relating to live plants, said fold-out brochure having a plurality of folded panels; and
a clear polyester polymeric film overlying said brochure and having a first edge extending beyond an edge of said brochure, said first edge having a contact adhesive thereon for attaching said brochure to one of a plant tag and plant pot and a second edge opposite said first edge and extending beyond an opposite edge of said brochure, said second edge having a releasable adhesive such that access to said brochure is obtained by peeling away said second edge from one of said tag and pot to which said brochure is attached.

9. The brochure as defined in claim 8 wherein said brochure includes at least three panels which are accordion folded with one of said panels having an outer surface to which said film is adhered.

10. The brochure as defined in claim 9 wherein at least one of said panels of said brochure has printed indicia on opposite sides.

11. The brochure as defined in claim 10 wherein said brochure includes five accordion folded panels and wherein each panel includes printed indicia on opposite sides.

12. The brochure as defined in claim 11 wherein said tag has a photograph of a plant and said outer surface of said one panel of said brochure has at least part of the same photograph which aligns with the photograph of said tag.

13. The brochure as defined in claim 12 wherein said film has one edge engaging one of said tag and plant pot that includes an adhesive deadener such that said film can be peeled away to open said brochure while remaining attached to one of said tag and pot.

14. A plant tag comprising:
a tag for use in association with a potted plant, said tag having a surface exposed to carry plant identification information thereon;
a fold-out paper brochure carrying printed indicia thereon pertaining to live plants, said fold-out brochure having a plurality of folded panels; and
a clear polymeric film overlying said brochure and having a first edge with a contact adhesive thereon for attaching said brochure to said surface of said tag and a second edge with a releasable adhesive such that access to said brochure can be obtained by peeling away said second edge from said tag.

15. The tag as defined in claim 14 wherein said brochure includes at least three panels which are accordion folded.

16. The tag as defined in claim 15 wherein at least one of said panels of said brochure has printed indicia on opposite sides.

17. The tag as defined in claim 16 wherein said brochure includes five accordion folded panels and wherein each panel includes printed indicia on opposite sides.

18. The tag as defined in claim 17 wherein said tag is made of a polymeric material.

19. The tag as defined in claim 18 wherein said polymeric film is a polyester film.

20. The brochure as defined in claim 14 wherein said tag has a photograph of a plant and an outer surface of said brochure has at least part of the same photograph which aligns with the photograph of said tag.
